(19) United States
(12) Patent Application Publication
(10) Pub. No.: US 2014/0172187 A1
(43) Pub. Date: Jun. 19, 2014

(54) APPARATUS AND METHOD FOR CONTROLLING SNOW MODE OF VEHICLE

(71) Applicants: KIA MOTORS CORPORATION, Seoul (KR); HYUNDAI MOTOR COMPANY, Seoul (KR)

(72) Inventor: Ho Wook Lee, Seoul (KR)

(73) Assignees: KIA MOTORS CORPORATION, Seoul (KR); HYUNDAI MOTOR COMPANY, Seoul (KR)

(21) Appl. No.: 13/895,626

(22) Filed: May 16, 2013

(30) Foreign Application Priority Data
Dec. 18, 2012 (KR) 10-2012-0148366

(51) Int. Cl. B60W 30/00

(52) U.S. Cl. CPC B60W 30/00
USPC 701/1

(57) ABSTRACT

An apparatus and a method that control a snow mode of a vehicle. The apparatus and method that control the snow mode of the vehicle temporarily remove a snow mode from a plurality of driving modes by disabling the snow mode on warmer temperatures days when a snow mode operation of a vehicle is not necessary to prevent the snow mode from being set due to a driver mistake while reducing a pressing frequency of a button required to switch to another driving mode without passing through the snow mode when switching to the another driving mode.

### CROSS-REFERENCE TO RELATED APPLICATION

This application is based on and claims priority from Korean Patent Application No. 10-2012-0148366, filed on Dec. 18, 2012 in the Korean Intellectual Property Office, the disclosure of which is incorporated herein in its entirety by reference.

### BACKGROUND OF THE INVENTION

1. Field of the Invention

The present invention relates to an apparatus and a method that controls a snow mode of a vehicle, and more particularly, to a technology of temporarily removing a snow mode from driving modes by disabling the snow mode on warmer temperature days to prevent the snow mode from being set due to a driver mistake while reducing a pressing frequency of a button required to switch to another driving mode without passing through the snow mode when switching to the another driving mode.

2. Description of the Prior Art

In a vehicle set for a user to select a driving mode, a method that controls a driving mode of the vehicle is designed to switch a driving mode to a sport mode, a snow mode, and an economy (ECO) mode based on the number of press inputs on a driving mode button, starting in a normal mode (e.g., wherein an alternate driving mode has not been selected) unconditionally at the time of initial starting.

That is, when the driving mode button is pressed once, the driving mode is first switched to the sport mode, when the driving mode button is pressed once again, to the snow mode, and when the driving mode button is pressed once again, to the economy mode. The switching of the driving mode is circularly repeated according to the pressed frequency of the driving mode button. Therefore, the snow mode may be enabled even in the warmer temperature days (e.g., summer season) when the snow mode is unnecessary, that is, the snow mode is included in the driving mode options despite the exterior temperature.

### SUMMARY

Accordingly, the present invention provides an apparatus and a method that controls a snow mode of a vehicle to temporarily remove the snow mode from driving mode options by disabling the snow mode on warmer temperature days when the snow mode of a vehicle is unnecessary (e.g., the exterior temperature is above at which snow is possible) to prevent the snow mode from being set due to a driver mistake while reducing a pressing frequency of a button required to switch to another driving mode without passing through the snow mode when switching to the another driving mode.

In one aspect of the present invention, an apparatus that controls a snow mode of a vehicle may include a plurality of units executed by a controller having a processor and a storage device. The plurality of units may include: a temperature sensing unit configured to sense a temperature; a determination unit configured to determine whether the temperature sensed by the temperature sensing unit exceeds a threshold value; and a mode control unit configured to disable a snow mode as a driving mode option of a vehicle when the temperature sensed by the temperature sensing unit exceeds the threshold value as the determination result by the determination unit, and enable the snow mode when the temperature sensed by the temperature sensing unit does not exceed the threshold value according to the determination result by the determination unit.

In another aspect of the present invention, a method that controls a snow mode of a vehicle may include: sensing, by a temperature sensor, temperature; determining, by a controller, whether the sensed temperature exceeds a threshold value; disabling, by the controller, a snow mode from a plurality of driving modes of a vehicle when the sensed temperature is determined to exceed the threshold value; and enabling, by the controller, the snow mode from the plurality of driving modes of a vehicle when the sensed temperature is determined not to exceed the threshold value.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram of an apparatus the controls a snow mode of a vehicle according to an exemplary embodiment of the present invention; and

FIG. 2 is an exemplary flow chart of a method that controls a snow mode of a vehicle according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail with reference to the accompanying drawings.

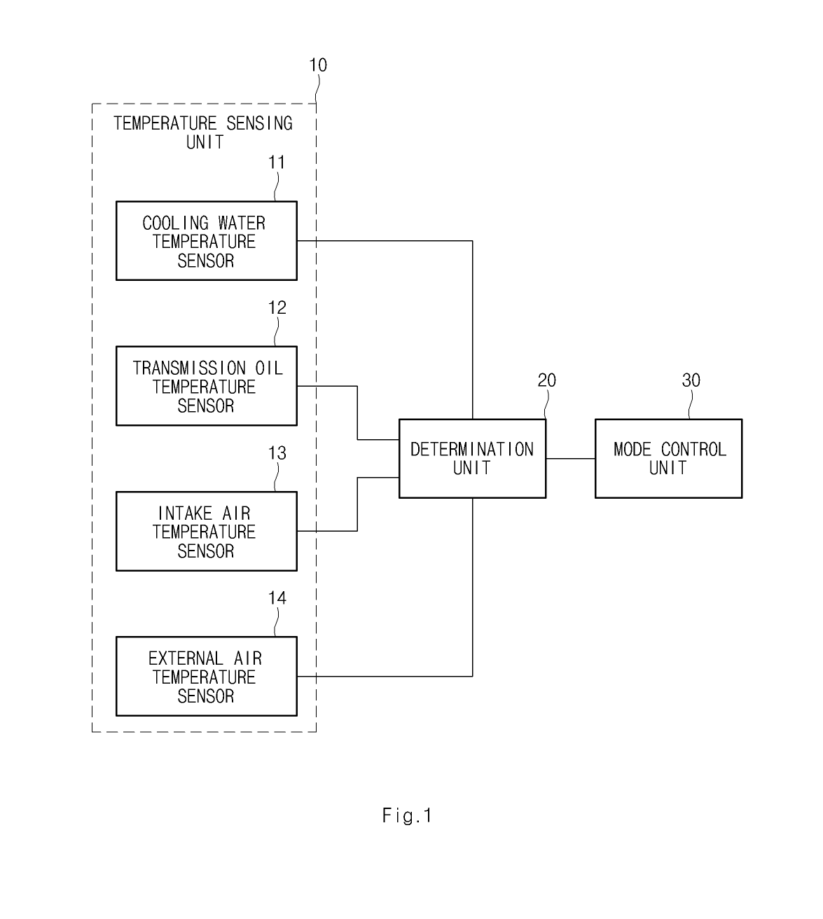

FIG. 1 is an exemplary diagram of an apparatus that controls a snow mode of a vehicle according to an exemplary embodiment of the present invention. As illustrated in FIG. 1, the apparatus that controls a snow mode of a vehicle may include a plurality of units executed by a controller having a processor and a storage device. The plurality of units may include: a temperature sensing unit 10, a determination unit 20, and a mode control unit 30.

Prior to describing each component, a vehicle to which the present invention is applied may be designed to sequentially switch a driving mode to a sport mode, a snow mode, and an economy (ECO) mode based on the number of press inputs on a driving mode button. Therefore, a driver may not set, for example, the economy mode without passing through the snow mode.

First, the temperature sensing unit 10 may be configured to sense a temperature required to determine whether the snow mode of a vehicle is enabled or disabled. That is, the temperature sensing unit 10 may be configured to measure the current temperature used to determine the temporary removal of the snow mode. In addition, the temperature sensing unit 10 may include a cooling water temperature sensor 11, a transmission oil temperature sensor 12, an intake air temperature sensor 13, and an external air temperature sensor 14.

The cooling water temperature sensor 11, that is a sensor configured to detect a temperature of engine cooling water, may be configured to detect a change in temperature as a change in a resistance value. In other words, the temperature of engine cooling water may be detected using a principle that when water temperature is below a predetermined temperature, the resistance value may increase and as water temperature increases, the resistance value decreases. The transmission oil temperature sensor 12 that is a sensor configured to sense the temperature of transmission oil may be configured to use the sensed temperature of transmission oil to control an oil pressure of a clutch and an oil pressure of a damper clutch, thereby reducing a shock occurrence during a shift operation. The intake air temperature sensor 13 may be configured to use a negative temperature coefficient (NTC) element having characteristics in which resistance is decreased as temperature increases to measure a temperature of air suctioned into an engine. The external air temperature sensor 14 may be configured to measure an exterior temperature of a vehicle.

Moreover, the determination unit 20 may be configured to determine whether the temperature sensed by the temperature sensing unit 10 exceeds a threshold value. In other words, the determination unit 20 may be configured to determine whether the temperature sensed by the cooling water temperature sensor 11 exceeds a first threshold value. Further, the determination unit 20 may be configured to determine whether the temperature sensed by the transmission oil temperature sensor 12 exceeds a second threshold value. In addition, the determination unit 20 may be configured to determine whether the temperature sensed by the intake air temperature sensor 13 exceeds a third threshold value. Furthermore, the determination unit 20 may be configured to determine whether the temperature sensed by the external air temperature sensor 14 exceeds a fourth threshold value.

Consequently, the determination unit 20 may be configured to determine whether at least any one of the temperature sensed by the cooling water temperature sensor 11, the temperature sensed by the transmission oil temperature sensor 12, the temperature sensed by the intake air temperature sensor 13, and the temperature sensed by the external air temperature sensor 14 exceeds the corresponding threshold value.

The mode control unit 30 may be configured to enable and disable the snow mode from the plurality of the driving modes of a vehicle according to the determination result from the determination unit 20. In other words, the mode control unit 30 may be configured to disable the snow mode when the determination unit 20 determines that the temperature sensed by the temperature sensing unit 10 exceeds the threshold value. That is, the snow mode is removed. Further, the mode control unit 30 may be configured to enable the snow mode when the determination unit 20 determines that the temperature sensed by the temperature sensing unit 10 is equal to or less than (e.g., does not exceed) the threshold value. Therefore, a driver may set the snow mode as desired.

In other words the mode control unit 30 may be configured to disable the snow mode from the plurality of driving modes of a vehicle when the determination unit 20 determines that the temperature sensed by the temperature sensor 11 exceeds the first threshold value. Further, the mode control unit 30 may be configured to disable the snow mode when the determination unit 20 determines that the temperature sensed by the transmission oil temperature sensor 12 exceeds the second threshold value. In addition, the mode control unit 30 may be configured to disable the snow mode when the determination unit 20 determines that the temperature sensed by the intake air temperature sensor 13 exceeds the third threshold value. Further, the mode control unit 30 may be configured to disable when the determination unit 20 determines that the temperature sensed by the external air temperature sensor 14 exceeds the fourth threshold value.

Consequently, the mode control unit 30 may be configured to disable the snow mode from the plurality of driving modes of a vehicle when at least any one of the temperature sensed by the cooling water temperature sensor 11, the temperature sensed by the transmission oil temperature sensor 12, the temperature sensed by the intake air temperature sensor 13, and the temperature sensed by the external air temperature sensor 14 exceeds the corresponding threshold value.

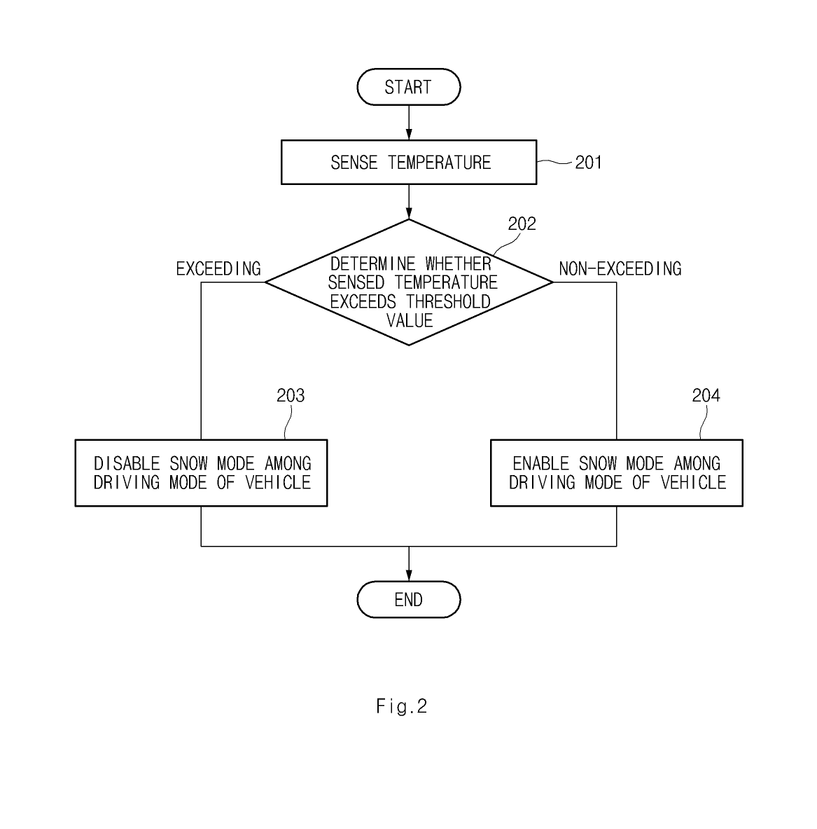

FIG. 2 is an exemplary flow chart of a method that controls a snow mode of a vehicle according to another exemplary embodiment of the present invention. The method may include sensing, by a temperature sensor, a temperature (201); determining, by a controller, whether the sensed temperature exceeds a threshold value (202); in response to determining that the sensed temperature exceeds the threshold value, disabling, by the controller, the snow mode from the plurality of driving modes of a vehicle (203); and in response to determining that the sensed temperature is equal to or less than (e.g., does not exceed) the threshold value, enabling the snow mode (204). The foregoing process is performed when the vehicle is started and as the performance result, may be performed until the starting of a vehicle stops.

Moreover, the exemplary embodiment of the present invention may further include an intake air temperature table based on the driving time and an external air temperature table according to the driving time. In particular, the determination unit 20 may be configured to determine whether the snow mode is enabled/disabled, based on the intake air temperature table and the external air temperature table.

Further, in the exemplary embodiment of the present invention, the enabling of the snow mode may cause the snow mode to be included in the menu of the driving modes, and may not necessarily cause the snow mode to be selected as a driving mode. Similarly, the disabling of the snow mode may cause the snow mode to be removed from the menu of the driving modes, and may not necessarily cause the snow mode operation to be disabled. A driver may not set the snow mode when the snow mode is removed from the menu of the plurality of driving modes.

As set forth above, according to the exemplary embodiments of the present invention, the snow mode may be temporarily removed from the plurality of driving modes by disabling the snow mode on warmer temperatures days, thereby preventing the snow mode from being set due to a driver mistake while reducing the pressing frequency of the button required to switch to another driving mode without passing through the snow mode when switching to the another driving mode.

Although the present invention was described with reference to exemplary embodiments and drawings, the present invention is not limited thereto and may be changed and modified in various ways within the spirit of the present invention and claims described below by those skilled in the art.

What is claimed is:

1. An apparatus that controls a snow mode of a vehicle, comprising:
a temperature sensing unit including a plurality of sensors configured to sense a plurality of temperatures;
a controller configured to:
determine whether the temperatures sensed by the temperature sensing unit exceeds a threshold value; and
disable a snow mode from a plurality of driving modes of the vehicle when the sensed temperatures exceed the threshold value.

2. The apparatus according to claim 1, wherein the controller is further configured to:
enable the snow mode from the plurality of driving modes of the vehicle when the sensed temperatures are equal to or less than the threshold value.

3. The apparatus according to claim 1, wherein the temperature sensing unit includes at least one of: a cooling water temperature sensor, a transmission oil temperature sensor, an intake air temperature sensor configured to measure a temperature of air suctioned into an engine, and an external air temperature sensor configured to measure an exterior temperature of a vehicle.

4. The apparatus according to claim 3, wherein the controller is further configured to:
determine whether at least any one of temperatures sensed by the cooling water temperature sensor, temperature sensed by the transmission oil temperature sensor, temperature sensed by the intake air temperature sensor, and temperature sensed by the external air temperature sensor exceed the corresponding threshold value.

5. The apparatus according to claim 4, wherein the controller is further configured to:
disable a snow mode from the plurality of driving modes of the vehicle when at least any one of the temperatures sensed by the cooling water temperature sensor, the temperature sensed by the transmission oil temperature sensor, the temperature sensed by the intake air temperature sensor, and the temperature sensed by the external air temperature sensor exceed the corresponding threshold value.

6. The apparatus according to claim 1, wherein the disabling snow mode may cause the snow mode to be removed from the menu of the driving modes.

7. A method that controls a snow mode of a vehicle, comprising:
sensing, by a temperature sensing unit including a plurality of sensors, a plurality of temperatures;
determining, by a controller, whether the sensed temperatures exceed a threshold value; and
disabling, by the controller, a snow mode from a plurality of driving modes of the vehicle when the sensed temperatures exceed the threshold value.

8. The method according to claim 7, further comprising:
enabling, by the controller, the snow mode from the plurality of driving modes of the vehicle when the sensed temperatures are equal to or less than the threshold value.

9. The method according to claim 7, wherein the temperature sensing unit includes:
a cooling water temperature sensor configured to sense a cooling water temperature;
a transmission oil temperature sensor configured to sense a transmission oil temperature;
an intake air temperature sensor configured to sense an intake air temperature suctioned into an engine; and
an external air temperature sensor configured to sense an exterior air temperature of the vehicle.

10. The method according to claim 9, further comprising:
determining, by the controller, whether at least any one of the cooling water temperature, the transmission oil temperature, the intake air temperature, and the exterior air temperature exceeds the corresponding threshold value.

11. The method according to claim 10, further comprising:
disabling the snow mode, when at least any one of the cooling water temperature, the transmission oil temperature, the intake air temperature, and the external air temperature exceeds the corresponding threshold value.

12. The method according to claim 7, wherein the disabling snow mode may cause the snow mode to be removed from the menu of the driving modes.

13. A non-transitory computer readable medium containing program instructions executed by a processor or controller, the computer readable medium comprising:
program instructions that control a temperature sensing unit including a plurality of sensors, to sense a plurality of temperatures;
program instructions that determine whether the sensed temperatures exceed a threshold value; and
program instructions that disable a snow mode from a plurality of driving modes of the vehicle when the sensed temperatures exceed the threshold value.

14. The non-transitory computer readable medium of claim 13, further comprising:
program instructions that enable the snow mode from the plurality of driving modes of the vehicle when the sensed temperatures are equal to or less than the threshold value.

15. The non-transitory computer readable medium of claim 13, wherein the temperature sensing unit includes:
a cooling water temperature sensor configured to sense a cooling water temperature;
a transmission oil temperature sensor configured to sense a transmission oil temperature;
an intake air temperature sensor configured to sense an intake air temperature suctioned into an engine; and
an external air temperature sensor configured to sense an exterior air temperature of the vehicle.

16. The non-transitory computer readable medium of claim 15, further comprising:
program instructions that determine whether at least any one of the cooling water temperature, the transmission oil temperature, the intake air temperature, and the exterior air temperature exceeds the corresponding threshold value.

17. The non-transitory computer readable medium of claim 16, further comprising:
program instructions that disable the snow mode, when at least any one of the cooling water temperature, the transmission oil temperature, the intake air temperature, and the external air temperature exceeds the corresponding threshold value.
